(19) United States
(12) Patent Application Publication
(10) Pub. No.: US 2007/0220370 A1
(43) Pub. Date: Sep. 20, 2007

(54) Mechanism to generate functional test cases for service oriented architecture (SOA) applications from errors encountered in development and runtime

(75) Inventors: Steven Joseph Branda, Rochester, MN (US); John Joseph Stecher, Rochester, MN (US)

Correspondence Address: IBM CORPORATION, 3605 HIGHWAY 52 NORTH, DEPT 917, ROCHESTER, MN, 55901-7829, US

(73) Assignee: International Business Machines Corporation, Armonk, NY (US)

(21) Appl. No.: 11/330,686

(22) Filed: Jan. 12, 2006

(51) Int. Cl. G06F 11/00

(52) U.S. Cl. 714/49

(57) ABSTRACT

A method for autonomically detecting and recreating exceptions occurring in a runtime environment during software development/testing. Dynamically-generated code of an exception detecting and recreating (EDR) utility is inserted into the application programming interface (API) entry points to the server to store method call parameter states by either cloning the objects or implementing Java serialization/de-serialization. The runtime listens for exceptions to be thrown and generates a java file that allows the API to be later invoked with the stored parameters for the specific interaction that generated/caused the exception. When the application is stopped, the java files generated are packaged into an application that will run on the server and allow re-execution of the problem paths.

### BACKGROUND OF THE INVENTION

1. Technical Field

The present invention relates generally to computer-based processes and in particular to computer-based runtime processes. Still more particularly, the present invention relates to a method and system for handling exceptions that occur during computer-based runtime processes.

2. Description of the Related Art

Computer application program development typically includes a penultimate state that involves testing and debugging of the application code executing on a data processing (computer) device. This stage of application program development is typically conducted by developers and/or particular testing personnel referred to as testers/debuggers. Currently, most development environments allow for testers to be attached to the executing computer device while the application code is stepped through. This method allows real time viewing of parameters and code flow by the testers. In other development environments, there are typically tools that generate testing harnesses wrapped around application code being developed to unit test simple functions.

During pre-production testing, it is common for exceptions (i.e., errors or faults) to occur when executing the application code. When these errors occur, conventional methods rely on the testers to physically identifying the errors and/or to identify the errors by implementing these unit testing tools. For example, with conventional methods, when an exception occurs, the developers/testers sift through piles of stack traces and attempt to retrace the exact transaction that caused the error to occur. Then, the developers either rerun that specific transaction or generate a test case to run that transaction.

With this conventional hands-on method, the more complex identification and debugging processes may take the developer/tester as much as a whole day to debug what actually happened and pinpoint the problem that resulted in the exception for that specific test case. Several very complex conventional software products, such as JBOSS and other application servers, are being used in testing environments. Currently the only tooling available to programmers with these products are the simple unit test generation tools and a few higher level API unit test tools which are helpful but only provide a limited amount of detail. Being able to recreate these errors (or error conditions) is an integral part of identifying the errors and correcting them. Even with the utilization of manual testers/debuggers and the unit test generation tools, however, there is an ever increasing need to be able to quickly identify and re-create these faults.

### SUMMARY OF THE INVENTION

Disclosed are a method, a system and a computer program product for autonomically detecting and recording exceptions occurring in a runtime environment during software development/testing. An exception-detection and recreation (EDR) utility is added to a server's runtime and executes to provide a series of functions that enable detection of exceptions that occur in the program code at the application programming interfaces (APIs). When test applications are installed, dynamically-generated code is inserted into the (API) entry points to the server to store copies of the method call parameter state(s).

With the functionality of the EDR utility, the runtime inserts hooks into the JDK (java development kit) and listens for exceptions to be thrown by the specific interactions of the executing application code. When an exception occurs, the runtime generates a java file with the stored parameters of the specific interaction that caused the exception. The generated java file allows the API to be invoked with the same saved off parameters. The runtime continues to listen for exceptions until execution of the application is stopped. Java files are generated for each exception that occurs.

When the application is stopped, the generated java files that are relevant to the future testing of the application are all packaged into an exception testing (ET) application, while the other files are deleted. The ET application may be stored to a storage medium and later executed as an application on the server or as a client during the next start of the original tested application. The ET application enables the tester/developer to re-execute the problem paths in some simple manner.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an exemplary diagram of a distributed network system having an application server in accordance with one embodiment of the present invention;

FIG. 2A is an exemplary block diagram of a data processing system utilized as an application server in accordance with one embodiment of the present invention;

FIG. 2B is a block diagram representation of the application programming interfaces (APIs) that are monitored by the servers runtime for exceptions occurring within an executing application, according to one embodiment of the invention; and

FIG. 3 is a flow chart illustrating the various steps of the processes by which exceptions occurring within an executing application are detected and re-created, according to one embodiment of the invention.

### DETAILED DESCRIPTION OF AN ILLUSTRATIVE EMBODIMENT

The present invention provides a method, a system and a computer program product for autonomically detecting and recording exceptions occurring in a runtime environment during software development/testing. An exception-detection and recreation (EDR) utility is added to an application server's runtime and executes to provide a series of functions that enable detection of exceptions that occur in the application code at the application programming interfaces (APIs). When test applications are installed, dynamically-generated code is inserted into the (API) entry points to the server to store copies of the parameters (objects) and parameter state(s) that provide the method calls.

With the functionality of the EDR utility, the runtime inserts hooks into the JDK (java development kit) and listens for exceptions to be thrown by the specific interactions of the executing application code. When an exception occurs, the runtime generates a java file with the stored parameters of the specific interaction that caused the exception. The generated java file allows the API to be invoked with the same saved off parameters. The runtime continues to listen for exceptions until execution of the application is stopped. Java files are generated for each exception that occurs.

When the application is stopped, the generated java files that are relevant to the future testing of the application are all packaged into an exception testing (ET) application, while the other files are deleted. This process removes the files from the system and stores relevant files to a pre-established storage medium that is accessed via a pre-programmed (or pre-identified) path. The ET application may be stored to a local or remote (attached or removable) storage medium, and the ET application may then be later executed as an application on the server or as a client during the next start of the original tested application. The ET application enables the tester/developer to re-execute the problem paths in some simple manner. In one embodiment, for example, remote method invocation (RMI) calls are made passing the parameters that caused the errors by invoking a simple method call.

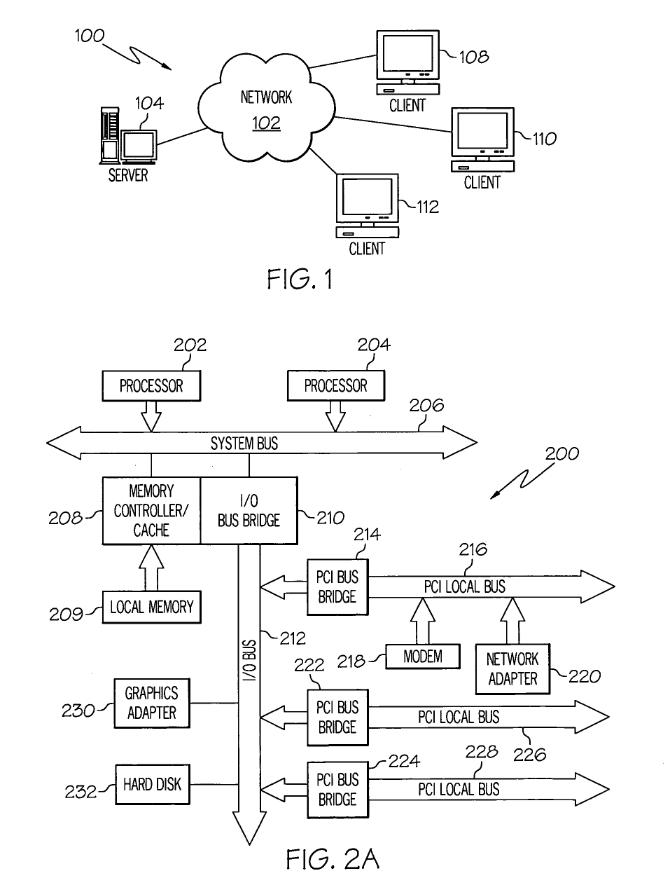

With reference now to the figures, FIG. 1 depicts a pictorial representation of a network of data processing systems (network system 100) in which the present invention may be implemented. Network system 100 contains network 102 (also referred to as a network backbone/infrastructure), which is the medium utilized to provide communication links between various devices and computers connected together within network system 100. Network 102 may include connections, such as wire, wireless communication links, or fiber optic cables.

In the depicted example, network system 100 comprises server 104 and multiple clients 108, 110, and 112 connected to network 102. Server 104 is depicted along with an associated storage unit 106, which is also connected to network 102. Clients 108, 110, and 112 may be, for example, personal computers or network computers. In the depicted example, server 104 provides data, such as boot files, operating system images, and applications to clients 108, 110, 112. In the described embodiment, server 104 functions as an application server, such as WebSphere Application Server (WAS) available from International Business Machines Corporation. Network system 100 may include additional servers, clients, and other devices not shown.

In the described embodiment, network system 100 is the Internet with network 102 representing a worldwide collection of networks and gateways that utilize the Transmission Control Protocol/Internet Protocol (TCP/IP) suite of protocols to communicate with one another. Of course, network system 100 also may be implemented as a number of different types of networks, such as an intranet, a local area network (LAN), or a wide area network (WAN), for example. FIG. 1 is intended as an example, and not as an architectural limitation for the present invention.

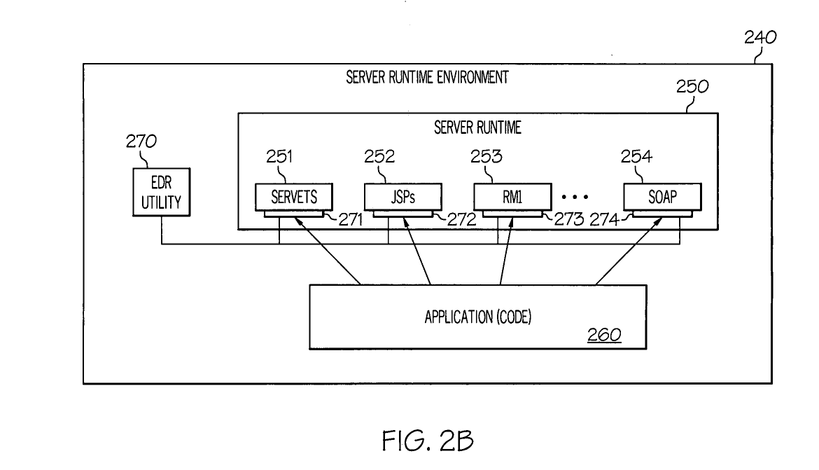

Referring now to FIG. 2A, there is depicted a block diagram representation of a data processing system that may be implemented as a server, such as application server 104 in FIG. 1, in accordance with the illustrative embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted (or not).

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110, 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2A may vary. For example, other peripheral devices, such as optical disk drives and the like, also may be used in addition to or in place of hardware depicted. Thus, the depicted example is not meant to imply architectural limitations with respect to the present invention. The data processing system depicted in FIG. 2A may be, for example, an IBM eServer pSeries system, a product of International Business Machines Corporation in Armonk, N.Y., running the Advanced Interactive Executive (AIX) operating system or LINUX operating system.

Notably, in addition to the above described hardware components of data processing system 200, various features of the invention (in particular EDR utility) are provided as application program code stored within memory 209 or other storage (of connected clients, for example) and executed by processor(s) 202/204. Among the software code are code for providing application server functionality, code for enabling network connection and communication via modem 218 and/or network adapter 220, and more specific to the invention, EDR utility code for enabling the application debugging-type features described herein. For simplicity, the collective body of code that enables the exception detection and other features are referred to hereinafter as EDR utility.

Features of the invention are implemented within an application server, in which the EDR utility is executed. Application servers are software applications in an intranet/Internet environment that host a variety of language systems used to program database queries and/or perform general business processing. An example of a web-based application server, as they are often called, is WebSphere Application Server. WebSphere is a registered trademark of International Business Machines (IBM) Corporation. In one embodiment, the application server being described herein is a WebSphere® application server and the EDR utility is added to Websphere server's runtime and operates to detect exceptions that occur in an application program undergoing development or an application being executed within a testing mode scenario. The EDR utility may then be provided as a plug-in to the Websphere runtime.

In actual implementation, EDR utility may be added to existing application server code to provide the enhanced debugging functionality described. EDR utility comprises several main functional components (although additional components may be packaged with EDR utility), a launch function, a monitoring and detection function, a file generation and packaging function, and a re-drive/re-execution function.

Depending on implementation, the above EDR utility functions may be provided/activated at application development or install time. When the user installs a J2EE (Java platform Version 2 Enterprise Edition) application, the installation proceeds to deploy the applications enterprise java beans (ejb's), JSPs, and other components. When deployed, the application target specific services API's (application programming interfaces) that are called/accessed during execution of the application.

With reference now to FIG. 2B, the described embodiment may be implemented within a generalized server runtime environment 240 (such as WebSphere runtime), although the method/process is applicable to any other middleware product with well defined APIs. As a service oriented architecture (SOA), server runtime environment 240 provides a series of well defined APIs for each service being exposed. As illustrated, server runtime environment 240 provides a series of entry points (APIs) to a server runtime in J2EE. These APIs include Servlets 251, JSPs 252, RMI 253, and SOAP 254. Other APIs may also be provided, though not specifically illustrated, such as messaging infrastructure, J2C compliant connectors, and others.

One method of implementing the above described process is by providing an application (or generated test application) 260 to a WebSphere runtime in a preproduction environment. The described embodiment provides the ability for a runtime, such as WebSphere to automatically generate test cases based on exceptions that occur in the runtime on specific transactions which breach clearly defined programming APIs. In the illustrated example, application 260 under-goes a first execution to determine if the application code contains any bugs (errors, etc.). Alternatively, application 260 may be tested as a part of a pilot program in which a subset of clients (not shown) is directed to the application 260 to test the application out before placing the application in production.

EDR utility 270 provides a monitoring function 271-274 associated with each API 251-254 within server runtime 250. As further described below, the monitoring functions 271-274 monitor transactions for exceptions being thrown across boundaries of respective APIs 251-254. Monitoring functions 271-274 also records the parameters associated with each process occurring at that API 251-254. When one of the monitoring functions 271-274 detects the occurrence of an exception, the monitoring function (271-274) triggers EDR utility 270 to generate a new unit test case, which is later utilized to drive the same parameters into the system so that the problem can be easily reproduced. Essentially, EDR utility 270 provides the test cases back to the tester/user for use in debugging or autonomically building a high quality system or function verification test bucket (i.e., a series of tests that encompasses the entire application. This enables the building of a larger test harness covering all possible errors that are encountered over time in order to develop a better quality software application.

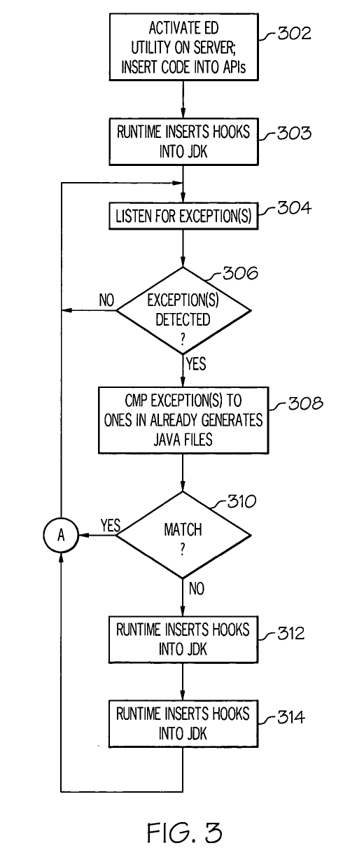

FIG. 3 illustrates the process steps completed by the EDR utility, according to one embodiment. As shown, the process begins at block 302, which depicts the activation of the EDR utility on the server runtime to initiating the monitoring and other features related to the occurrence of exceptions (e.g., problems, faults and/or errors) on the APIs. When applications are installed, EDR utility provides dynamically-generated EDR code that is inserted into the API entry points to the server runtime.

Following, at block 304, the runtime inserts hooks into the JDK (Java Development Kit) and listens for exceptions to be thrown by the specific interaction. A determination is made, as indicated at block 306, whether an exception has occurred. If no exception(s) occur, the process continues to monitor the API entry points. Notably, with no exceptions occurring, the only change (i.e., decrease) in processing time is the code insertion performed at block 302, and the developer merely expends the cost of the exception listener.

According to the invention, the EDR code inserted into the APIs saves off method call parameter state(s). This function involves either cloning/copying the objects (method call parameters) or utilizing known Java serialization/de-serialization, which provides a quick way to copy the object(s). The cloning/copying (or serialization/de-serialization) process allows the later generation of test cases, which will provide (or pass) the same arguments to the APIs as the arguments that caused the originally detected exception.

Returning to FIG. 3, when an exception occurs, the runtime performs a checks, as shown at block 308, to see if the exception is for a set of parameters and API call that already generated a java file. This check is performed before generating each java file in order to eliminate generation of a large number of overlapping or repeating test cases as may occur in situations where multiple similar calls to that API(s) produce a same error. If there is no match of exception-producing parameters within the already generated java files, the runtime generates a new test case java file, as shown in block 310. Otherwise no new java file is generated.

The java files generated by the runtime allows the API(s) to be invoked with the saved off parameters for the interaction that caused the exception. The runtime also writes the exception to the java file as a comment, as indicated at block 312, so that the developer/debugger may clearly see that the test case produced a specific kind of error. In one embodiment, the java file is built to allow the file to be easily run against the application server. For example, if the call that caused the exception traversed Servlet API 251, then a servlet would be generated that tests Servlet API 251 with the parameters saved during the interaction occurring prior to block 306. During the test, these parameters are provided as arguments to try and recreate the exception so that intelligent and efficient debugging and future testing may take place.

Returning to the flow chart, once the java file is generated, processing returns to normal and future exceptions are listened for as shown at block 314. If another exception occurs, runtime again performs the above process of determining whether or not to create a new java file. Finally, when execution of the application is stopped, the generated java files are packaged into an exception test (ET) application as shown at block 314. This ET application may then be run on the server or as a client at a next start of the original tested application. In one embodiment, the java files generated are cleaned up by an autonomic process or by a debugger prior to completing the packaging into the ET application.

By completing the above process, the application tester/debugger is able to re-execute the problem paths within the test application by simply running the packaged ET application. When the ET application is run, the RMI calls pass the parameters that caused the original exceptions through the system. In one embodiment, the tester runs the ET application by invoking a simple method call, e,g., “test1”, which triggers execution of the ET application.

The present invention provides a method for autonomically generating test cases when faults occur in an application running on the server. Implementation of this method helps to raise the level of quality for applications being deployed into production environments. The invention recognizes that errors occurring in pre-production testing (or pre-deployment) have to be evaluated and corrected before testing and that there is a significant benefit from being able to reproduce or re-drive the interaction with the runtime server that caused the errors in a testing environment for debugging purposes to ensure that the fault(s) is/are addressed and/or corrected.

The present invention recognizes that there is a significant benefit from being able to reproduce or re-drive the interaction(s) with the data processing device that caused the exceptions in a testing environment for debugging purposes to ensure that each exception is identified and addressed expeditiously and does not occur in the future. The present invention also recognizes that such faster identification and recreation would enable equally fast correction of the errors/faults within application code. The invention further recognizes that being able to directly identify exceptions as they occur rather than rely on human analysis or observation of the code improves the overall level of quality of applications being deployed into production environments, as there is less likelihood of an exception being missed by the human eye.

The above described processes (or steps thereof) combined together to produce a unique and powerful dynamic test generation tool for the runtime that will make customers more productive as well as help the customers minimize errors. The process also speeds the time taken to debug an applications pilot or testing phase, allowing applications to be placed into production faster than current methods.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system operating as a runtime server, a method comprising:
autonomically inserting tracking code of an exception detection and recreation (EDR) utility into the application programming interfaces (APIs) of the server;
dynamically monitoring executing processes of an application for occurrence of exceptions; and
dynamically generating a java file comprising the method call parameters that resulted in the exception.

2. The method of claim 1, wherein:
said monitoring step further comprises copying the method call parameters provided at the APIs via one of direct copying and Java serialization/de-serialization; and
said dynamically generating further comprises generating test cases via the java files comprising similar method call parameters as the method call parameters that generated the exceptions.

3. The method of claim 1, further comprising:
automatically aggregating each java file generated during execution of the application into an exception test (ET) application; and
enabling execution of the ET application on the server's runtime to recreate parameter states that generated the original exceptions.

4. The method of claim 3, wherein the automatically aggregating step further comprises:
determining which generated java files are relevant for application debugging;
deleting other java files that are determined to not be relevant for application debugging; and
combining the remaining java file not deleted into the ET application.

5. The method of claim 3, wherein:
the dynamically monitoring comprises monitoring transactions and parameters associated with each process occurring at the API; and
when the dynamically monitoring process detects the exception, said method comprises:
checking method call parameters of existing java files to determine whether exception detected results from a new method call parameter or a previously recorded method call parameter; and
triggering the generation of a new java file comprising a copy of the method call parameters and parameter states when the particular method call parameter is a new method call parameter that has not been previously recorded within an existing java file.

6. The method of claim 1, wherein the server is a Websphere application server and the processes execute via a Websphere runtime, wherein further the step of autonomically inserting tracking code of an EDR utility into the APIs of the server comprise inserting hooks into a java development kit (JDK) to listen for exceptions thrown by specific interactions of application transactions and processes with the APIs.

7. The method of claim 1, wherein said dynamically monitoring further comprises performing the monitoring at each of the APIs of the server, wherein specific method calls to a particular API that generates an exception are recorded within respective java files generated, wherein a same method call detected later does not generate a new java file.

8. The method of claim 1, said dynamically generating further comprises writing the exception to the java file as a comment.

9. A computer program product comprising:
a computer readable medium; and
program code stored on the computer readable medium that when executed provides the functions of:
autonomically inserting tracking code of an exception detection and recreation (EDR) utility into the application programming interfaces (APIs) of the server;
dynamically monitoring executing processes of an application for occurrence of exceptions; and
dynamically generating a java file comprising the method call parameters that resulted in the exception.

10. The computer program product of claim 9, wherein:
said program code for monitoring further comprises code that when executed performs the function of copying the method call parameters provided at the APIs via one of direct copying and Java serialization/de-serialization; and
said program code for dynamically generating further comprises code that when executed performs the function of generating test cases via the java files comprising similar method call parameters as the method call parameters that generated the exceptions.

11. The computer program product of claim 9, further comprising program code for:
automatically aggregating each java file generated during execution of the application into an exception test (ET) application; and
enabling execution of the ET application on the server's runtime to recreate parameter states that generated the original exceptions.

12. The computer program product of claim 11, wherein the program code for automatically aggregating further comprises code for:
determining which generated java files are relevant for application debugging;
deleting other java files that are determined to not be relevant for application debugging; and
combining the remaining java file not deleted into the ET application.

13. The computer program product of claim 11, wherein:
the program code for dynamically monitoring comprises code for monitoring transactions and parameters associated with each process occurring at the API; and
when the dynamically monitoring process detects the exception, said program code comprises code for:
checking method call parameters of existing java files to determine whether exception detected results from a new method call parameter or a previously recorded method call parameter; and
triggering the generation of a new java file comprising a copy of the method call parameters and parameter states when the particular method call parameter is a new method call parameter that has not been previously recorded within an existing java file.

14. The computer program product of claim 9, wherein the server is a Websphere application server and the processes execute via a Websphere runtime, wherein further the program code for autonomically inserting tracking code of an EDR utility into the APIs of the server comprises code for inserting hooks into a java development kit (JDK) to listen for exceptions thrown by specific interactions of application transactions and processes with the APIs.

15. The computer program product of claim 9, wherein said code for dynamically monitoring further comprises code for performing the monitoring at each of the APIs of the server, wherein specific method calls to a particular API that generates an exception are recorded within respective java files generated, wherein a same method call detected later does not generate a new java file.

16. The computer program product of claim 9, said program code for dynamically generating further comprises code for writing the exception to the java file as a comment.

17. A data processing system comprising:
at least one processor;
a server runtime executing on the processor and providing one or more application programming interfaces (APIs) for access by executing applications;
a computer readable medium connected to the processor; and
program code stored on the computer readable medium that when executed by the processor provides the functions of:
autonomically inserting tracking code of an exception detection and recreation (EDR) utility into the APIs of the server runtime;
dynamically monitoring executing processes of an executing application for occurrence of exceptions; and
dynamically generating a java file comprising the method call parameters of the executing application that resulted in the exception and writing the exception to the java file as a comment;
wherein said program code for dynamically generating further comprises code that when executed performs the function of generating test cases via the java files comprising similar method call parameters as the method call parameters that generated the exceptions;

18. The data processing system of claim 17, wherein:
said program code for dynamically monitoring further comprises code that when executed performs the function of copying the method call parameters provided at the APIs via one of direct copying and Java serialization/de-serialization;
said program code for dynamically monitoring comprises code for monitoring transactions and parameters associated with each process occurring at the API; and
when the dynamically monitoring process detects the exception, said program code comprises code for:
checking method call parameters of existing java files to determine whether exception detected results from a new method call parameter or a previously recorded method call parameter; and
triggering the generation of a new java file comprising a copy of the method call parameters and parameter states when the particular method call parameter is a new method call parameter that has not been previously recorded within an existing java file.

19. The data processing system of claim 17, said program code further comprising code for:
automatically aggregating each java file generated during execution of the application into an exception test (ET) application, wherein the program code for automatically aggregating further comprises code for:
determining which generated java files are relevant for application debugging;
deleting other java files that are determined to not be relevant for application debugging; and
combining the remaining java file not deleted into the ET application; and
enabling execution of the ET application on the servers runtime to recreate parameter states that generated the original exceptions.

20. The data processing system of claim 17, wherein:
the server runtime is a Websphere application server runtime, wherein further the program code for autonomically inserting tracking code of an EDR utility into the APIs of the server comprises code for inserting hooks into a java development kit (JDK) to listen for exceptions thrown by specific interactions of application transactions and processes with the APIs; and
said program code for dynamically monitoring further comprises code for performing the monitoring at each of the APIs of the server, wherein specific method calls to a particular API that generates an exception are recorded within respective java files generated, wherein a same method call detected later does not generate a new java file.
